(19) United States
(12) Patent Application Publication
(10) Pub. No.: US 2022/0350060 A1
(43) Pub. Date: Nov. 3, 2022

(54) Diffraction Element Fixing Device

(71) Applicant: Nippon Telegraph and Telephone Corporation, Tokyo (JP)

(72) Inventors: Shin Toyota, Musashino-shi, Tokyo (JP); Sohan Kawamura, Musashino-shi, Tokyo (JP)

(21) Appl. No.: 17/760,858

(22) PCT Filed: Oct. 3, 2019
(86) PCT No.: PCT/JP2019/039205

§ 371 Date: Mar. 16, 2022

(51) Int. Cl. G02B 5/18; H01S 3/04

(52) U.S. Cl. CPC G02B 5/1876; H01S 3/0401; H01S 3/0404

(57) ABSTRACT

Provided is a fixing device for a diffraction element including an element installation portion where a diffraction element is installed, and an element fixing portion that fixes the diffraction element installed on the element installation portion, wherein the element installation portion includes an element installation surface for curving the installed diffraction element in a discretionary shape, and the element installation surface is formed in an arch-like shape such that deformation of the diffraction element due to pressure of a cooling fluid is reduced.

### TECHNICAL FIELD

The present invention relates to a fixing device for an optical diffraction element and particularly to a fixing device for a reflective diffraction element.

### BACKGROUND ART

Optical diffraction elements, represented by Fresnel lenses, are optical components that utilize the wave motion characteristic of light and convert patterns of light intensity and that are used in various industrial fields. Fresnel lenses utilize periodicity at a pitch of wavelengths for light with a constant wavelength, allowing a typically thick lens to be replaced with a thin lens.

Currently, in addition to Fresnel lenses that focus light, various reflective diffraction elements, such as a diffraction mirror, with a diffraction pattern formed on a light-reflecting mirror surface for reflecting and converting the light into various forms of light beams are being developed and used as optical diffraction elements used in wave optics.

As described in NPL 1, one application of this technology is a high power laser for processing, and a reflective diffraction element is also used in laser resonator optical systems and laser beam transmission optical systems. Typical examples of a continuous output high power laser include a gas dynamic laser or a chemical laser, both of which have an oscillation wavelength of a longer wavelength in the infrared region. Thus, a metal reflective mirror formed of metal is often used as the material of a diffraction mirror for beam shaping developed for heat ray lasers.

A metal reflective mirror is unable to function as a high reflectivity mirror, such as a dielectric multi-layer film, in the infrared region, with there being an approximately 2% light energy absorption in the diffraction mirror. In a case of a megawatt-class laser device, this 2% light energy absorption results in approximately 20 kilowatts of heat input being regularly present in the diffraction mirror, leading to increased risk of thermal deformation and thermal damage of the diffraction mirror.

In order to avoid thermal deformation of the diffraction mirror as much as possible and prevent thermal damage, not only must the material of the optical substrate of the diffraction mirror be considered, but also the cooling mechanism needs to be considered. An example of a cooling mechanism for a diffraction mirror includes impinging the back surface of the mirror with air containing water droplets to cool the mirror via the heat of evaporation of the water droplets. In this method, in a case where the mirror is made of a material that is resistant to high temperatures, the cooling efficiency can be improved by an amount relative to how high the temperature is compared to room temperature operation.

In order to efficiently cool a mirror like the one in the example described above, the cooling medium needs to be directly impinged on the mirror. However, as the flow rate of the refrigerant increases, the cooling capacity increases, causing the pressure of the cooling medium applied to the mirror to increase. This may cause the curvature to be changed due to deformation of the mirror. In particular, with a metal reflective mirror such as a reflective diffraction element constituted by a metal plate having a thickness less than that of a refractive lens, the deformation due to the effect of pressure is large, so the curvature of the reflective diffraction element may have slightly a different value when used compared to when designed. This deviation in curvature changes the focal length of the diffraction light, thereby complicating the design of the optical system.

### CITATION LIST

### Non Patent Literature

NPL 1: Kenichi UEDA, High power laser adaptive optical system, Laser Research, Vol. 27-2, pp. 84-88, 1999

### SUMMARY OF THE INVENTION

### Technical Problem

As described above, in the application of a high power lasers, large heat generation occurs in the diffraction element, and a large amount of cooling fluid is needed for cooling. However, the pressure from a large amount of cooling fluid may warp the diffraction element, leading to the focal length problematically changing from the designed focal length.

In light of the foregoing, an object of the present invention is to provide a fixing device for implementing the use of a diffraction element with high power light that fixes a diffraction element in a shape that is less susceptible to warping due to pressure of a cooling fluid and is able to resist deformation.

### Means for Solving the Problem

In a fixing device of the present invention, a diffraction element is fixed in a shape, such as one with an arch-like cross-section, that is able to reduce deformation and is fixed with a structure resistant to deformation due to pressure. Thus, the diffraction element does not deform significantly even when subjected to large water pressure or air pressure for cooling, and the focal length according to specifications can be used.

Examples of embodiments of the present invention include the following configurations to achieve the above object.

Configuration 1

A fixing device for a diffraction element includes:
an element installation portion with an upper surface on which a diffraction element is installed; and
an element fixing portion that sandwiches and fixes an edge portion of the diffraction element installed on the element installation portion, wherein
an element installation surface for deforming and supporting the diffraction element is formed on an inner wall surface of the element installation portion; and
the element installation surface is formed with a surface shape for curving and installing the diffraction element in a shape such that deformation of the diffraction element due to pressure of a cooling fluid flowing inside the element installation portion is reduced.

Configuration 2

In the fixing device for a diffraction element according to Configuration 1,
surface shapes of two of the element installation surfaces formed on two of the inner wall surfaces of the element installation portion that are opposing are formed in an identical curved surface shape with a central portion in a longitudinal direction raised in an arch-like shape or reversely concave; and
an element fixing surface with a reversed curved surface shape corresponding to the curved surface shape of the element installation surfaces is formed at a portion of the element fixing portion corresponding to the element installation surface.

Configuration 3

In the fixing device for a diffraction element according to Configuration 2,
one set or a plurality of sets of grooves parallel with a bottom surface of the element installation portion with an equal height from the bottom surface are formed on two of the inner wall surfaces of the element installation portion that are opposing, the two of the inner wall surfaces not having the element installation surface; and
two end surfaces of the diffraction element are inserted and fixed in one corresponding set of the grooves.

Configuration 4

In the fixing device for a diffraction element according to any one of Configurations 1 to 3, one of the two of the inner wall surfaces of the element installation portion where the element installation surface is not provided is constituted by a length adjustment portion for changing an effective length of the element installation surface; and
a gap between the diffraction element and the element installation portion is closed by adjusting the length adjustment portion and changing the effective length of the element installation surface.

Configuration 5

In the fixing device for a diffraction element according to Configuration 4,
a cushioning portion is disposed between the element installation portion and the length adjustment portion to close the gap.

Configuration 6

The fixing device for a diffraction element according to any one of Configurations 1 to 5, wherein
an installation surface forming portion for forming the element installation surface on the inner wall surface of the element installation portion is provided individually; and
a height adjustment portion for adjusting a height of a position of the installation surface forming portion is further provided individually.

Configuration 7

In the fixing device for a diffraction element according to any one of Configurations 1 to 6,
a cushioning material or a filler is disposed between the element installation portion or the element fixing portion and the diffraction element to prevent leakage of the cooling fluid.

### Effects of the Invention

According to a fixing device for a diffraction element as described above, a diffraction element is fixed in a shape, such as one with an arch-like cross-section, that is able to reduce deformation and is fixed with a structure resistant to bending. Thus, the diffraction element does not deform significantly even when subjected to large water pressure or air pressure for cooling, and the focal length substantially according to specifications can be used.

### BRIEF DESCRIPTION OF DRAWINGS

FIG. 1 is a cross-sectional view of the overall configuration of a fixing device for a reflective diffraction element of the present invention in an in-use state as seen from a side surface according to a first embodiment.

FIGS. 2(a) and 2(b) are cross-sectional views of a side surface of an element installation portion and an element fixing portion of a fixing device according to the first embodiment.

FIGS. 3(a) and 3(b) are top views of the element installation portion and the element fixing portion of the fixing device of the first embodiment.

FIG. 4 is a perspective view of an element installation portion of the fixing device of the first embodiment.

FIG. 5 is a perspective view of an element fixing portion of the fixing device of the first embodiment as seen from the rear surface side.

FIGS. 6(a) and 6(b) are cross-sectional views of a side surface of an element installation portion and an element fixing portion of a fixing device according to another example of the first embodiment.

FIG. 7(a) is a cross-sectional view of a side surface of an element installation portion of the fixing device of the second embodiment, and FIG. 7(b) is a top view of an element fixing portion of the fixing device of the second embodiment.

FIG. 8(a) is a cross-sectional view of a side surface of an element installation portion and an element fixing portion of a fixing device according to a third embodiment, and FIG. 8(b) is a top view of the element installation portion.

FIG. 9(a) is a cross-sectional view of a side surface of an element installation portion and an element fixing portion of a fixing device according to a fourth embodiment, and FIG. 9(b) is a top view of the element installation portion.

Hereinafter, embodiments of the present invention will be described with reference to the accompanying drawings. In the following embodiments, a fixing device of a laser device using a reflective diffraction element is described. However, the present invention has many varying applications and should not be construed as being limited to the contents described below.

### First Embodiment

Overall Configuration in In-use State

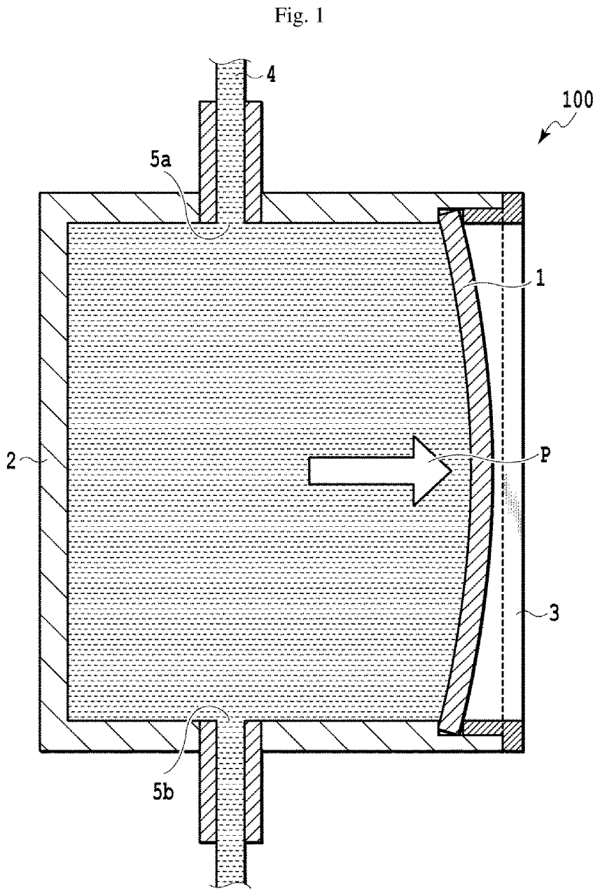

FIG. 1 is a cross-sectional view illustrating an overall configuration of a fixing device for a reflective diffraction element according to a first embodiment of the present invention in an in-use state. A fixing device 100 according to the first embodiment is a fixing device for fixing a reflective diffraction element 1, such as a diffraction mirror constituted by a substantially rectangular metal plate or the like.

The diffraction element 1, as illustrated in FIG. 1, has an arch-like shape cross-section as seen from the side surface and is constituted by a rectangular metal plate with a diffraction pattern designed on the basis of the surface shape for operation formed in the front surface (the surface on the right side in FIG. 1). Laser beams incident on the diffraction element 1 from the left side of FIG. 1 are diffracted and reflected, shaping the beams.

The fixing device 100 according to the first embodiment of FIG. 1 includes an element installation portion 2 where the diffraction element 1, which is the object for cooling and the object for fixing, is fixed; and an element fixing portion 3 for fixing the diffraction element 1 installed in the element installation portion 2 by sandwiching the edge portion of the diffraction element 1 from the right in FIG. 1. The element installation portion 2 includes an element installation surface formed with a curved surface shape capable of curving and holding the installed diffraction element 1 in any shape. In this manner, the curved surface shape of the element installation surface of the element installation portion 2 can be an arch-like shape, for example, so as to reduce the effect of deformation of the diffraction element 1 due to pressure P of a cooling fluid 4.

In the first embodiment, the diffraction element 1 is cooled from the back surface by applying pressure and making the cooling fluid 4 flow from outside to inside the fixing device. Thus, the diffraction element 1 receives the pressure P from the cooling fluid 4 acting toward the outside of the fixing device.

In FIG. 1, the cooling fluid 4 is a refrigerant that is fed inside the element installation portion 2 by an external device such as a chiller or a fan (not illustrated), and the medium is constituted by any one or more of a liquid, a gas, or a solid. The cooling fluid 4 may be a sol-like fluid in which solid microparticle with specific heat is suspended in a gas or liquid, for example.

The cooling fluid 4 passes through a circulation path from an external device (not illustrated) and is forced inside the fixing device via a flow inlet 5a on the upper side of FIG. 1. Then, after the heat is directly taken from the back surface (rear surface) of the diffraction element 1, the cooling fluid 4 flows out to the circulation path via a flow outlet 5b on the lower side of FIG. 1 and is circulated to the external device and dissipates heat.

The element installation portion 2 is a piece of hardware used to install the diffraction element 1, and the shape, material, installation angle, size, weight, fixing method, and the like are not limited by this embodiment.

An example of the element installation portion 2 includes a piece of hardware shaped like a substantially rectangular parallelepiped box-like container that is slightly smaller than the external shape of the diffraction element 1 and includes an opened upper surface for installing the rectangular plate-like diffraction element 1. The four-sided peripheral portion (edge portion) of the rectangular plate-like diffraction element 1 that serves as the lid of the upper surface of the box-like container may be fixed between the element fixing portion 3 that serves as the frame of the lid and the upper end of the inner wall surface of the element installation portion 2.

As illustrated in FIG. 1, the flow inlet 5a and the flow outlet 5b are provided on the inner wall surface of the rectangular parallelepiped element installation portion 2 vertically opposite one another, and the cooling fluid 4 flows into and out of the inside of the element installation portion 2 covered by the diffraction element 1, forming a circulation path. In this configuration, the cooling fluid 4 is brought into direct contact with the rear surface of the diffraction element 1, allowing for highly efficient cooling to be achieved.

The element fixing portion 3 is another piece of hardware for fixing the rectangular plate-like diffraction element 1 that is attached to the upper end or the inner wall surface of the element installation portion 2 and constitutes the frame of the diffraction element 1 that serves as the lid of the upper surface of the element installation portion 2. Here, the shape, material, angle, size, weight, fixing method, and the like are not limited by this example. As in the example described above, the element fixing portion 3 is only required to be a piece of hardware that can be attached to the element installation portion 2 sandwiching the edge portion of the diffraction element 1 and can secure the diffraction element 1 in an immovable state. Because the element fixing portion 3 can curve and secure the diffraction element 1, deformation and displacement of the diffraction element 1 due to the pressure P of the cooling fluid 4 can be reduced.

Configuration of Element Installation Portion and Element Fixing Portion

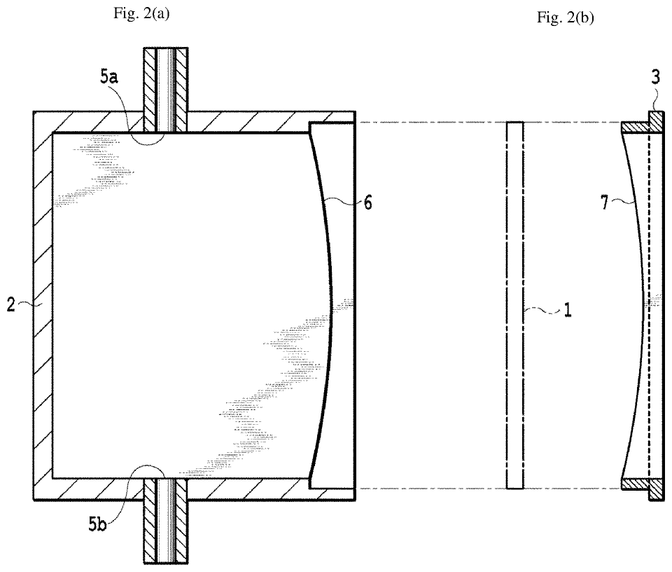

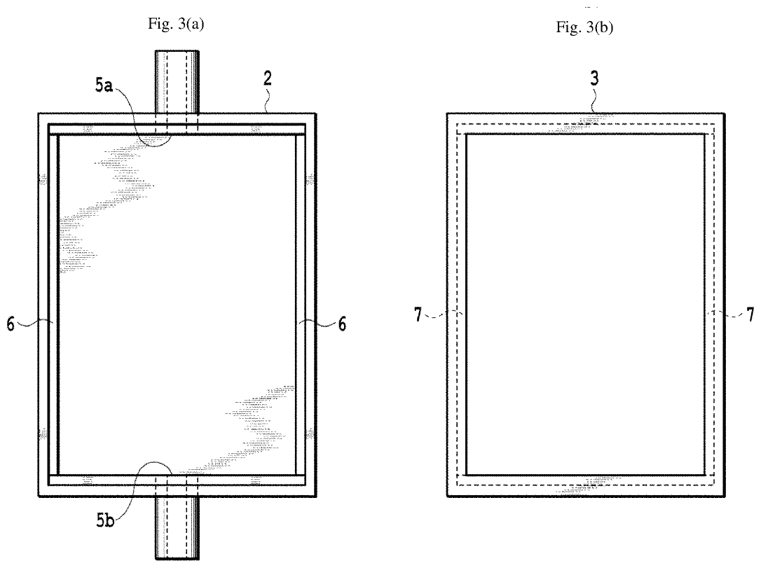

FIGS. 2(a) and 2(b) are cross-sectional views of the element installation portion 2 and the element fixing portion 3 of the fixing device 100 of the first embodiment as seen from the side surface. FIGS. 3(a) and 3(b) are top views of the element installation portion 2 and the element fixing portion 3 of the fixing device 100 of the first embodiment.

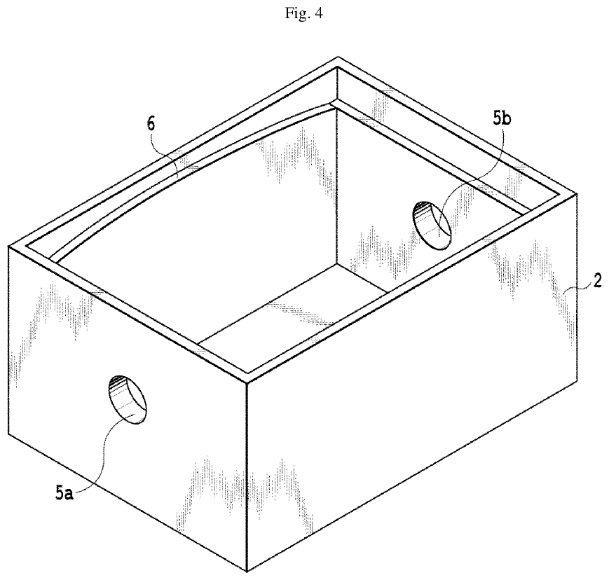

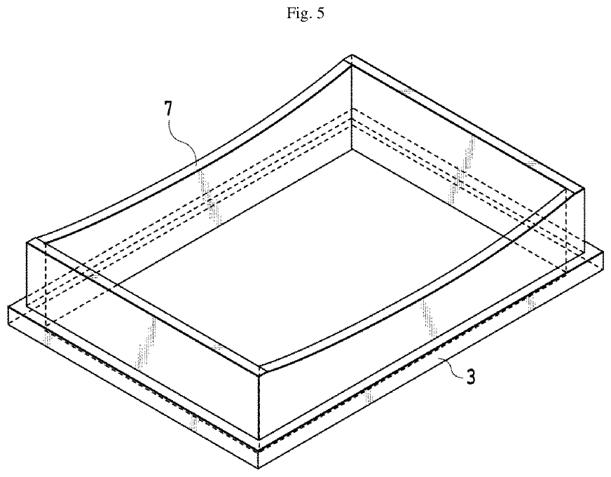

Also, FIG. 4 is a perspective view of the element installation portion 2, and FIG. 5 is a perspective view of the element fixing portion 3 as seen from the rear surface side. However, in FIG. 4, the pipe joint portion of the flow inlet 5a and the flow outlet 5b of the element installation portion 2 are omitted. It should be noted that in the perspective view of the element fixing portion 3 as seen from the rear surface side in FIG. 5, the element fixing portion 3 has a quadrangular frame-like shape with the central portion being a hollow cavity (opening).

The cross-sectional view of the element installation portion 2 as seen from the side surface in FIG. 2(a) is a cross-sectional view illustrating the cross-section perpendicular to the bottom surface (the left end surface in FIG. 2(a) of the element installation portion 2 including a straight line connecting the centers of the holes of the flow inlet 5a and the flow outlet 5b. FIG. 2(b) also illustrates a cross-section indicated by a broken line of the diffraction element 1 in the state before being sandwiched and fixed at a position between the element installation portion 2 and the element fixing portion 3.

In the cross-sectional view of the element fixing portion 3 in FIG. 2(b), an element fixing surface 7 with a reverse surface shape (concave) corresponding to the surface shape (convex) of an element installation surface 6 of the element installation portion 2. As illustrated in the top view of FIG. 3(b), the element fixing portion 3 is, generally speaking, a frame-like plate material such as a frame having an opening slightly smaller than the external shape of the diffraction element 1. Also, as illustrated in the rear surface perspective view in FIG. 5, the element fixing portion 3 has an element fixing structure that forms the element fixing surface 7 on the inner edge periphery of the opening on the rear surface.

As illustrated in the cross-sectional view in FIG. 2(a) and FIG. 4, a step structure with a step is formed in the upper end portion of the inner wall surface of the element installation portion 2. In the step structure, the thickness of the wall is formed thinner at the upper end surface side of the inner wall surface, and the thickness of the wall is formed thicker below a position down from the upper end of the wall past the thickness of the diffraction element 1.

As illustrated in FIG. 3(a), the surface of the step (the rise in the surface) perpendicular to the inner wall surface has a surface shape in which four sides of a rectangle along the inner wall of the element installation portion 2 have a width when viewed from the upper surface side of the element installation portion 2. Then, the surface of the step is a surface where the diffraction element 1 and the element installation portion 2 come into contact with each other and where the diffraction element 1 is supported. In this example, the two opposite sides (the vertically long sides in FIG. 3) of the rectangle of the step surface form the element installation surface 6, sharing the same curved surface. However, the element installation surface is not limited to the vertically long sides and may be two opposing horizontally short sides.

As illustrated in the perspective view of the element installation portion 2 in FIG. 4, the element installation surface 6 is formed into a curved convex arch-like curved surface shape that gently rises in the center in the longitudinal direction. The other element installation surface 6 of the pair hidden from view and not illustrated in FIG. 4 is also formed into the same convex arch-like curved surface shape. With this curved surface shape, the element installation portion 2 can curve and fix the diffraction element 1 installed thereon to have a gently arched cylindrical surface, for example, and can be fixed in a manner resistant to the pressure from the cooling fluid 4.

In order to prevent leakage of the cooling fluid 4, elastic, water resistant cushioning material (packing) made of rubber of a synthetic resin or filler (sealing material, caulking material) may be disposed in a peripheral gap between the inner wall surface of the element installation portion 2 and the diffraction element 1 on the surface of the step on the element installation surface 6 or the element fixing surface 7.

With the fixing device 100 having this structure, the diffraction element 1 can be supported on the surface of the step including the element installation surface 6 of the element installation portion 2 and sandwiched and fixed by element fixing surface 7 of the element fixing portion 3 on the upper surface side in a manner such that, in this fixed state, the cooling fluid 4 can be brought into contact with the rear surface of the diffraction element 1.

The shape, material, angle, and size of the element installation surface 6 are not limited by the drawings. However, as illustrated by the perspective view of FIG. 4, by the long sides of the element installation surface 6 being formed in an arch-like shape like an arc protruding outward relative to the fixing device, the diffraction element 1 overall is fixed in a curved shape with the shape of an arc protruding outward relative to the fixing device (an outer arch-like shape).

Then, as illustrated in the perspective view in FIG. 5, on the side (the upper side in FIG. 5) corresponding to the rear surface of the element fixing portion 3, a wall-like structure formed from the inner wall of the opening of the element fixing portion 3 forming a quadrangle is formed as an element fixing structure. The element fixing surface 7 with a reverse shape (concave arch-like shape) corresponding to the arch-like shape of the convex element installation surface 6 is formed on the upper end of the element fixing structure. The entire element fixing structure forming the element fixing surface 7 of the element fixing portion 3 is preferably shaped and sized to engage with the step structure forming the element installation surface 6 in the element installation portion 2.

Evaluation of Amount of Deflection Due to Arch-like Shape

In a case where the surface is formed in this manner, the amount of deflection of the diffraction element 1 when pressure is received is less when the diffraction element 1 is curved in an arch-like shape and fixed beforehand compared to being fixed flat in a flat plate-like manner, even when the pressure P received by the diffraction element 1 from the cooling fluid 4 flowing into the fixing device is the same.

For example, the material of the diffraction element 1 is SiC and the dimensions are 100×50×1 (mm). In a case where the diffraction element 1 is fixed in a flat manner, a deflection δ (mm) at the center portion of the diffraction element 1 obtained via

$$δ = \frac{5 {qL}^{4}}{384 EI}$$

where a uniformly distributed load applied in the vertical direction from the cooling fluid is q (N/mm), Young's modulus (N/mm²) is E, the length (mm) of the diffraction element 1 is L, and the cross-sectional secondary moment (mm⁴) is I.

In a case where the element installation surface 6 is formed in a flat manner, I=4.2 (mm⁴), E=4.3×10⁵ (N/mm²), and L=100 (mm). Thus, when the uniformly distributed load q=1 (N/mm), the amount of deflection is δ=0.73 (mm).

In contrast, in a case where the element installation surface 6 is formed in an arch-like shape and the diffraction element 1 is fixed in an arch-like shape (a semi-circular shape for example), the cross-sectional secondary moment I=48.6 (mm⁴), L=50 (mm), and the amount of deflection is δ=0.039 (mm), which is smaller than in the case where it is formed flat. Accordingly, by forming the element installation surface 6 in an arch-like shape, the amount of deflection of the diffraction element 1 can be reduced.

### First Embodiment—Another Example

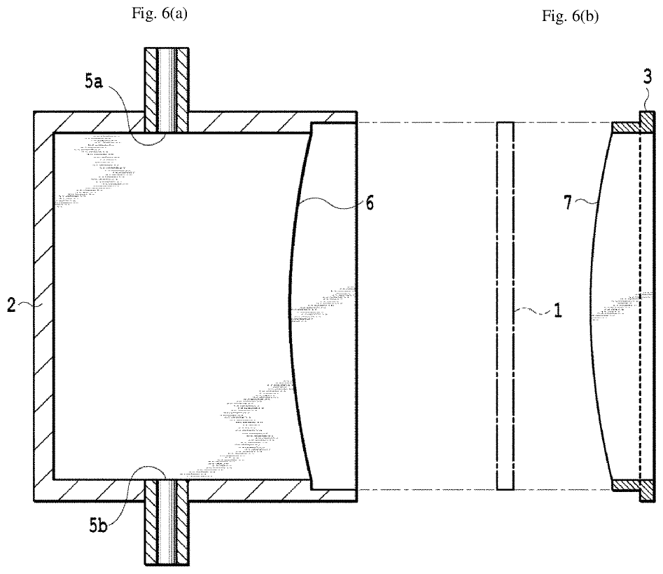

Additionally, as illustrated in another example of the fixing device according to the first embodiment of FIG. 6, the orientation of the arch of the element installation surface 6 of the element installation portion 2 may be curved and fixed with a reversed orientation (concave surface) to that illustrated in FIG. 2. In this case, the element fixing surface 7 on the rear surface of the corresponding element fixing portion 3 is a convex surface.

In a case where the element installation surface 6 has an inward arc-like shape (concave surface) in this manner, the uniformly distributed load q (N/mm) applied to the diffraction element 1 is balanced with the compression force of the diffraction element 1. In other words, a load can be considered to be applied in a direction parallel with the plate surface of the flat plate of the diffraction element 1. Thus, the amount of deformation AL due to the load can be expressed by

$$ε = \frac{Δ L}{L} , ε = \frac{qL}{bhE}$$

where the strain of the diffraction element is ε , the height of the diffraction element is h (mm), and the width of the diffraction element is b (mm).

When L=100 (mm), h=50 (mm), and b=1 (mm), strain ϵ=4.7×10⁻⁶ and ΔL=4.7×10⁻⁴ (mm). In a case where the diffraction element has an arch-like shape (a semicircular shape for example), the amount of decrease in the height of the rise of the arch when the arc length decreases by ΔL due to the load becomes equal, thus the amount of deflection δ=2.3×10⁻⁴ (mm). In other words, the amount of deformation is reduced in a case such as that illustrated in FIG. 6 where the arc-like shape protrudes inwards (the element installation surface 6 is concave) compared to a case such as that illustrated in FIG. 2 where the arc-like shape protrudes outward (the element installation surface 6 is convex).

From the foregoing, it can be seen that the first embodiment and the following embodiments are not limited in terms of the orientation of the arch being in the inward direction (concave surface) or the outward direction (convex surface), and either may be used.

### Second Embodiment

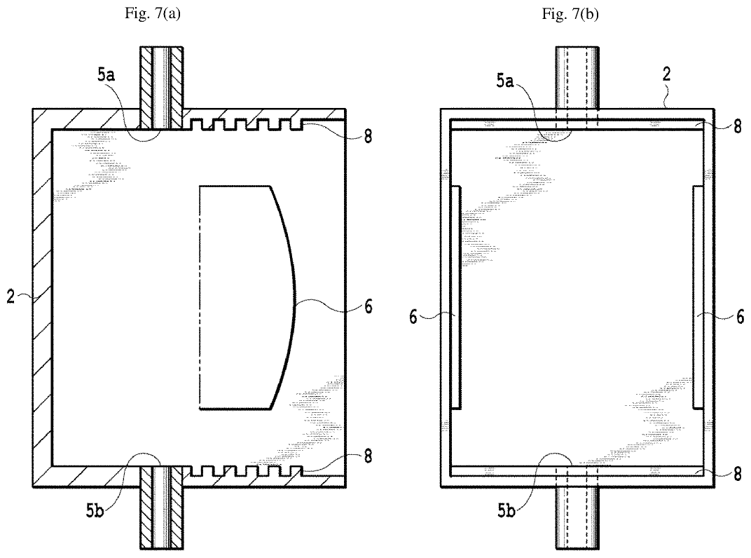

FIG. 7 is a diagram illustrating an example of the configuration of a fixing device according to the second embodiment. FIG. 7(a) is a cross-sectional view of a side surface of the element installation portion 2 and the element fixing portion 3 of the fixing device according to the second embodiment, and FIG. 7(b) is a top view of the element installation portion 2.

The fixing device of the second embodiment of FIG. 7 is a modified example of the first embodiment. The fixing device according to the second embodiment includes a plurality of grooves 8 formed on the inner wall surface where the element installation surface 6 of the element installation portion 2 is not provided so that an end surface on the short sides of the diffraction element 1 can be secured.

The plurality of grooves 8 are formed as sets on two opposing inner wall surfaces where the element installation surface 6 of the element installation portion 2 is not provided, running parallel with the bottom surface of the element installation portion 2 (the surface on the left end of FIG. 7(a)) at corresponding distances from the bottom surface. Furthermore, the plurality of grooves 8 have a structure in which a portion of the element installation surface 6 is opened to the outside to allow the diffraction element 1 to be received by the grooves 8.

With the fixing device according to the second embodiment of FIG. 7 having a configuration including these grooves 8, the element fixing portion 3 as well as the element installation portion 2 can be used to secure the diffraction element 1, and thus the ability to more reliably secure the diffraction element 1 without gaps is increased.

Additionally, with the fixing device according to the second embodiment, by disposing the plurality of grooves 8 in sets, the curvature of the diffraction element 1 can be changed by selecting the groove position to insert the diffraction element 1. By changing the curvature of the diffraction element 1, the focal point of the diffraction light can be adjusted.

In a case where the groove 8 position where to diffraction element 1 is to be fixed at is able to be selected allowing for adjustment, preferably the element installation surface 6 stops sufficiently before the grooves 8 and has a length less than that in the first example or the arch of the element installation surface 6 is formed with a large curvature. Alternatively, the element installation surface 6 may have a cylindrical surface with a low height. In FIG. 7(a), the shape on the opposite side of the element installation surface 6 is discretionary, and thus is omitted.

Although not illustrated in FIG. 7, the element fixing surface 7 on the rear surface of the element fixing portion 3 may have a gentle arch-like shape that is suitable for fixing in a case where the diffraction element 1 is fixed in the highest groove furthest away from the bottom surface, or element fixing surfaces 7 with shapes corresponding to a plurality of groove positions are prepared in advance and to one to use is selected therefrom.

In a case where gaps are created due to the position of the selected grooves such that leakage of the cooling fluid 4 is a concern, cushioning material (packing) or filler (sealing material, caulking material) may be disposed around the periphery of the diffraction element 1.

For example, take a case where 1 mm grooves 8 are formed in a five set parallel to one another in the inner wall on the short side of the element installation portion 2 at 1 mm intervals, and a portion of the element installation surface 6 is fixed and disposed on the inner wall on the long side. In this case, the curvature of the diffraction element 1 can be selected from five patterns according to the position of the grooves on the short side for receiving the diffraction element 1. As the focal length becomes shorter as the curvature increases, the focal length can be adjusted by changing in which grooves the diffraction element 1 is inserted. Of course, the size, arrangement interval, and the number of grooves are not limited by this example, and the shape and arrangement of the element installation surface is not limited by this example.

### Third Embodiment

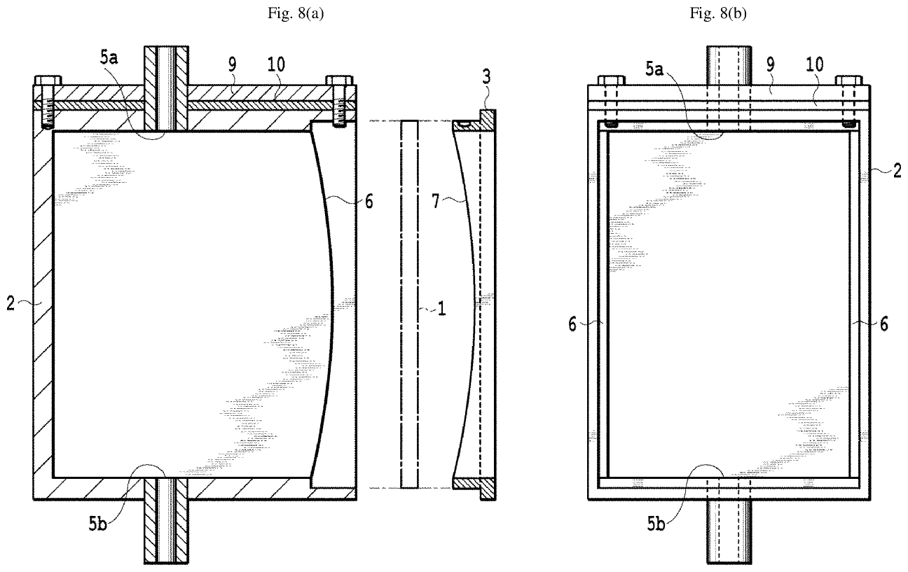

FIG. 8 is a diagram illustrating an example of the configuration of a fixing device according to the third embodiment. FIG. 8(a) is a side view of the element installation portion 2 and the element fixing portion 3 of the fixing device according to the third embodiment, and FIG. 8(b) is a top view of the element installation portion 2. The fixing device of the third embodiment is a modified example of the first and second embodiment.

The fixing device according to the third embodiment of FIG. 8 includes a length adjustment portion 9 for changing the effective length and dimensions of the element installation surface 6 and a cushioning portion 10 disposed between the length adjustment portion 9 and the element installation portion 2.

As illustrated in FIG. 8, the length adjustment portion 9 according to the third embodiment has a configuration in which one of the inner wall surfaces where the element installation surface 6 of the element installation portion 2 is not provided (the upper side surface where the flow inlet 5a is provided in FIG. 8(a)) is attached to the body of the element installation portion 2 and the element fixing portion 3 via a screw structure provided at the up, down, left, right four corners of the side surface sandwiching the cushioning portion 10.

The four screws extend through the length adjustment portion 9 and the cushioning portion 10 and are screwed into the wall surface of the element installation portion 2 or the element fixing portion 3, and screw threads that engage with the screws are formed in the inner surface of the screw holes formed corresponding to the four screws in the element installation portion 2 and the element fixing portion 3. The length adjustment portion 9 enables adjustment of the effective length of the element installation surface 6 within a range of the expansion and contraction range of the cushioning portion 10 via the depth at which the four screws are screwed in.

The length adjustment portion 9 of the third embodiment in FIG. 8 enables the element installation surface 6 is be adjusted and fixed so as to match the dimensions of the diffraction element 1 fixed in an arch-like shape by the length (effective dimension) of the element installation surface 6 being changed. As a result, the diffraction element 1 can be firmly fixed with various curvatures. Although FIG. 8 illustrates an example of a method for adjusting the length using four screws provided on both ends of the length adjustment portion 9, the length adjustment method is not limited to being manual or automatic, and the hardware used is not limited to screws, cylinders, cranks, and the like.

The cushioning portion 10 in FIG. 8 is disposed between the length adjustment portion 9 and the element installation portion 2 and has the effect of preventing leakage of the cooling fluid 4 from the gap between the length adjustment portion 9 and the element installation portion 2. Thus, it is desirable that the material of the cushioning portion 10 is an elastic material that is resistant to water, examples of which include rubber, synthetic resin, and the like. The shape, size, and arrangement are not limited by this example. In a similar manner to the first and second embodiments, in a case where gaps are created at other portions such that leakage of the cooling fluid 4 is a concern, cushioning material (packing, sealing material, caulking material) may be disposed.

### Fourth Embodiment

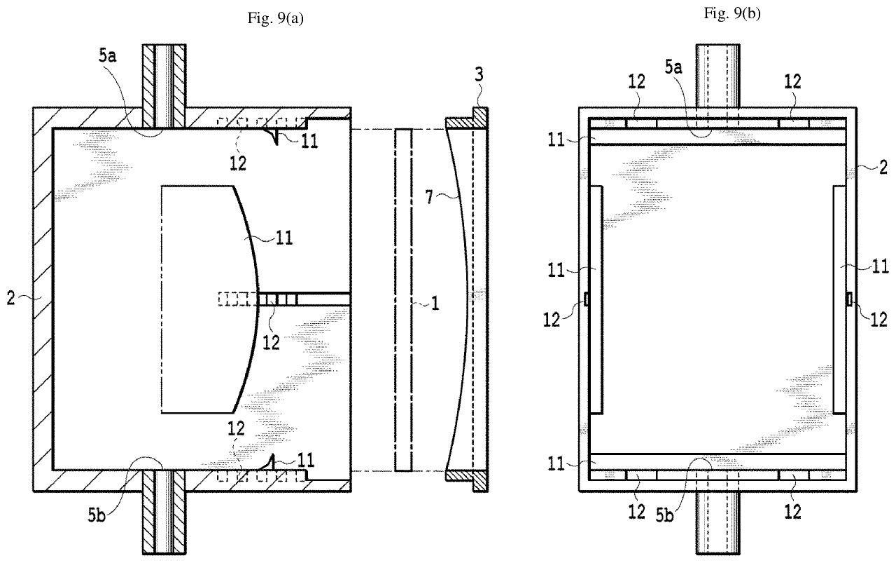

FIG. 9 is a diagram illustrating an example of the configuration of a fixing device according to the fourth embodiment. FIG. 9(a) is a side view of the element installation portion 2 and the element fixing portion 3 of the fixing device according to the fourth embodiment, and FIG. 9(b) is a top view of the element installation portion 2. The fixing device of the fourth embodiment is a modified example of the first to third embodiment.

The fixing device according to the fourth embodiment of FIG. 9 is provided, on each of the four wall surfaces on the inside of the element installation portion 2, with an installation surface forming portion 11 that forms an element installation surface that supports the diffraction element 1 and a height adjustment portion 12 that adjusts the arrangement (height from the bottom surface) of each installation surface forming portions 11.

The installation surface forming portion 11 is constituted by one or more components and forming a plurality of reference surfaces for installing the diffraction element 1 on the wall surfaces inside the element installation portion 2. This allows the element installation surfaces 6 to be formed independently in the wall surfaces with a discretionary shape, incline, and height. The shape of each of the components constituting the installation surface forming portion 11 may vary from one component to another, for example, the short side component may have a rectangular parallelepiped shape and the long side component may have a cylindrical shape. The component may have a curved shape as with the element installation surface 6 in FIG. 7(a) or may have a semi-circular shape.

The arrangement position may also vary from component to component. For example, the installation surface can be given an arch-like shape by disposing the short side at a lower portion (on the bottom surface side) than the long side. Of course, the shape, arrangement, size, material, number, and the like of the components are not limited, and the components may be the same or different from component to component.

The height adjustment portion 12 is a mechanism for installing the installation surface forming portion 11 at a position at a discretionary height of the inner wall surface of the element installation portion 2. The height adjustment portion 12 is constituted by one or more of a mechanism capable of securing the installation surface forming portion 11, such as a clip, a locking catch, a button, or the like; a mechanism for changing the installation position, such as a rail, engagement groove, band, or the like corresponding to the securing mechanism. In this manner, the arrangement (height) of the installation surface forming portion 11 can be changed. Naturally, the method of changing the installation position is not limited by the example described above, it is only required that the method enable the installation surface forming portion 11 to be attached at a discretionary plurality of positions, examples including but not being limited to forming a plurality of grooves for attaching installation surface forming portions 11, using an adhesive material for the installation surface forming portions 11, and the like.

FIG. 9 is a diagram illustrating an example in which the height adjustment portion 12, constituted by clips or locking catches for securing the installation surface forming portion 11 and a rail or a series of engagement grooves for position adjustment, is disposed on the inner wall surface of the element installation portion 2 and the installation surface forming portion 11 is fixed via clips. By moving the position of the clips or locking catches on the rail or series of engagement grooves, the installation surface forming portion 11 can be fixed at a desired height position, and an element installation surface for installing the diffraction element 1 in a discretionary shape can be formed.

The element fixing portion 3 according to the fourth embodiment of FIG. 9 is not provided with an adjustment portion corresponding to the element installation portion 2. However, a plurality of element fixing portions 3 including element fixing surfaces 7 having different shapes corresponding to the element installation surface formed on the element installing portion 2 may be prepared in advance, and the element fixing portion 3 with the optimal shape may be selected and used.

### Industrial Applicability

As described above, according to a fixing device for a diffraction element of the present invention, the diffraction element does not deform significantly even when subjected to large water pressure or air pressure for cooling, and the focal length substantially according to specifications can be used.

### REFERENCE SIGNS LIST

1 Diffraction element
2 Element installation portion
3 Element fixing portion
4 Cooling fluid
5a Flow inlet
5b Flow outlet
6 Element installation surface
7 Element fixing surface
8 Groove
9 Length adjustment portion
10 Cushioning portion
11 Installation surface forming portion
12 Height adjustment portion
100 Fixing device

1. A fixing device for a diffraction element, comprising:
an element installation portion with an upper surface on which a diffraction element is installed; and
an element fixing portion that sandwiches and fixes an edge portion of the diffraction element installed on the element installation portion, wherein
an element installation surface for deforming and supporting the diffraction element is formed on an inner wall surface of the element installation portion, and
the element installation surface is formed with a surface shape for curving and installing the diffraction element in a shape such that deformation of the diffraction element due to pressure of a cooling fluid flowing inside the element installation portion is reduced.

2. The fixing device for a diffraction element according to claim 1, wherein surface shapes of two of the element installation surfaces formed on two of the inner wall surfaces of the element installation portion that are opposing are formed in an identical curved surface shape with a central portion in a longitudinal direction raised in an arch-like shape or reversely concave, and an element fixing surface with a reversed curved surface shape corresponding to the curved surface shape of the element installation surface is formed at a portion of the element fixing portion corresponding to the element installation surface.

3. The fixing device for a diffraction element according to claim 2, wherein
one set or a plurality of sets of grooves parallel with a bottom surface of the element installation portion with an equal height from the bottom surface are formed on two of the inner wall surfaces of the element installation portion that are opposing, the two of the inner wall surfaces not having the element installation surface, and
two end surfaces of the diffraction element are inserted and fixed in one corresponding set of the grooves.

4. The fixing device for a diffraction element according to claim 1, wherein
one of the two of the inner wall surfaces of the element installation portion where the element installation surface is not provided is constituted by a length adjustment portion for changing an effective length of the element installation surface, and
by adjusting the length adjustment portion and changing the effective length of the element installation surface, a gap between the diffraction element and the element installation portion is closed.

5. The fixing device for a diffraction element according to claim 4, wherein
a cushioning portion is disposed between the element installation portion and the length adjustment portion to close the gap.

6. The fixing device for a diffraction element according to claim 1, wherein
an installation surface forming portion for forming the element installation surface on the inner wall surface of the element installation portion is provided individually; and
a height adjustment portion for adjusting a height of a position of the installation surface forming portion is further provided individually.

7. The fixing device for a diffraction element according to claim 1, wherein
a cushioning material or a filler is disposed between the element installation portion or the element fixing portion and the diffraction element to prevent leakage of the cooling fluid.

8. The fixing device for a diffraction element according to claim 2, wherein
one of the two of the inner wall surfaces of the element installation portion where the element installation surface is not provided is constituted by a length adjustment portion for changing an effective length of the element installation surface, and
by adjusting the length adjustment portion and changing the effective length of the element installation surface, a gap between the diffraction element and the element installation portion is closed.

9. The fixing device for a diffraction element according to claim 3, wherein
one of the two of the inner wall surfaces of the element installation portion where the element installation surface is not provided is constituted by a length adjustment portion for changing an effective length of the element installation surface, and
by adjusting the length adjustment portion and changing the effective length of the element installation surface, a gap between the diffraction element and the element installation portion is closed.

10. The fixing device for a diffraction element according to claim 2, wherein
an installation surface forming portion for forming the element installation surface on the inner wall surface of the element installation portion is provided individually; and
a height adjustment portion for adjusting a height of a position of the installation surface forming portion is further provided individually.

11. The fixing device for a diffraction element according to claim 3, wherein
an installation surface forming portion for forming the element installation surface on the inner wall surface of the element installation portion is provided individually; and
a height adjustment portion for adjusting a height of a position of the installation surface forming portion is further provided individually.

12. The fixing device for a diffraction element according to claim 4, wherein
an installation surface forming portion for forming the element installation surface on the inner wall surface of the element installation portion is provided individually; and
a height adjustment portion for adjusting a height of a position of the installation surface forming portion is further provided individually.

13. The fixing device for a diffraction element according to claim 5, wherein
an installation surface forming portion for forming the element installation surface on the inner wall surface of the element installation portion is provided individually; and
a height adjustment portion for adjusting a height of a position of the installation surface forming portion is further provided individually.

14. The fixing device for a diffraction element according to claim 2, wherein
a cushioning material or a filler is disposed between the element installation portion or the element fixing portion and the diffraction element to prevent leakage of the cooling fluid.

15. The fixing device for a diffraction element according to claim 3, wherein
a cushioning material or a filler is disposed between the element installation portion or the element fixing portion and the diffraction element to prevent leakage of the cooling fluid.

16. The fixing device for a diffraction element according to claim 4, wherein
a cushioning material or a filler is disposed between the element installation portion or the element fixing portion and the diffraction element to prevent leakage of the cooling fluid.

17. The fixing device for a diffraction element according to claim 5, wherein
a cushioning material or a filler is disposed between the element installation portion or the element fixing portion and the diffraction element to prevent leakage of the cooling fluid.

18. The fixing device for a diffraction element according to claim 6, wherein
a cushioning material or a filler is disposed between the element installation portion or the element fixing portion and the diffraction element to prevent leakage of the cooling fluid.
